(19) United States
(12) Patent Application Publication
(10) Pub. No.: US 2021/0317683 A1
(43) Pub. Date: Oct. 14, 2021

(54) MAGNETICALLY FASTENING APPARATUS

(71) Applicant: SINOX LOCK (KUNSHAN) CO., LTD., Kunshan (CN)

(72) Inventors: Xiaodi ZHANG, Kunshan (CN); Yonggang ZHOU, Kunshan (CN); Junlong YANG, Kunshan (US)

(21) Appl. No.: 17/267,584

(22) PCT Filed: Jul. 7, 2020
(86) PCT No.: PCT/CN2020/100675

§ 371 Date: Feb. 10, 2021

(30) Foreign Application Priority Data
Jul. 9, 2019 (CN) 201910614718.2

(51) Int. Cl. E05B 47/00; A44B 19/30; E05B 37/02; E05B 65/52

(52) U.S. Cl. CPC E05B 47/004; E05B 65/52; E05B 37/02; A44B 19/301

(57) ABSTRACT

Provided is a magnetically fastening apparatus. The magnetically fastening apparatus includes a zipper tab and a lock body. The zipper tab can fit with the lock body by magnetic attraction. The lock body is provided with a control member. The control member has a locking position and an unlocking position. The zipper tab can fit with the lock body by magnetic attraction when the control member is in the locking position. The zipper tab and the lock body are configured to release the magnetic attraction relationship between the zipper tab and the lock body when the control member is in the unlocking position.

The present application claims priority to Chinese Patent Application No. 201910614718.2 filed Jul. 9, 2019, the disclosure of which is incorporated herein by reference in its entirety.

### TECHNICAL FIELD

The present application relates to the technical field of luggage accessories and, for example, relates to a magnetically fastening apparatus.

### BACKGROUND

Luggage is an item for accommodating scattered articles or baggage in people's lives. Due to the rapid development of the tourism industry contemporarily, luggage is more and more demanded. Generally, luggage is provided with a lock. In the related art, the lock mounted on the luggage is mostly a coded lock or a keyed lock. The coded lock or the keyed lock fits with a zipper tab of a zipper on the luggage to lock the luggage. When the luggage needs to be opened, a password may be toggled, or a key may be plugged in and then be turned, so that the zipper tab is released.

In the related art, during the process when the zipper tab is locked, a user needs to keep pulling the zipper tab, plug the zipper tab into a lock hole, and then lock the luggage through the password or the key. During the process when the zipper tab is unlocked, the luggage is unlocked using the password or the key, and then the zipper tab is pulled out of the lock hole. These operations greatly depend on the user and are not convenient enough.

### SUMMARY

The present application provides a magnetically fastening apparatus. During the locking process or the unlocking process, a zipper tab can be automatically plugged into a lock hole or disengage from the lock hole.

An embodiment provides a magnetically fastening apparatus. The magnetically fastening apparatus includes a zipper tab and a lock body.

The zipper tab can fit with the lock body by magnetic attraction.

The lock body is provided with a control member. The control member has a locking position and an unlocking position. The zipper tab can fit with the lock body by magnetic attraction when the control member is in the locking position. The zipper tab and the lock body are configured to release the magnetic attraction relationship between the zipper tab and the lock body when the control member is in the unlocking position.

An embodiment provides a magnetically fastening apparatus. The magnetically fastening apparatus includes a movable member and a body.

The movable member can fit with the body by magnetic attraction.

The body is provided with a control member. The control member has a fastening position and a releasing position. The movable member can fit with the body by magnetic attraction when the control member is in the fastening position. The movable member and the body are configured to release the magnetic attraction relationship between the movable member and the body when the control member is in the releasing position.

### BRIEF DESCRIPTION OF DRAWINGS

FIG. 1 is a structural view of a magnetically fastening apparatus (in a locking state) according to an embodiment of the present application.

FIG. 2 is a structural view of a magnetically fastening apparatus (in an unlocking state) according to an embodiment of the present application.

FIG. 3 is an exploded view of a magnetically fastening apparatus according to an embodiment of the present application.

FIG. 4 is a structural view illustrating that a zipper tab of a magnetically fastening apparatus is plugged into a lock hole according to an embodiment of the present application.

FIG. 5 is a cross-sectional view taken along line B-B of FIG. 4.

FIG. 6 is a structural view illustrating the state in which lock bolts hook zipper tabs when a control member of a magnetically fastening apparatus is in a locking position according to an embodiment of the present application.

FIG. 7 is a structural view illustrating the state in which lock bolts disengage from zipper tabs when a control member of a magnetically fastening apparatus is in a releasing position according to an embodiment of the present application.

FIG. 8 is a structural view of a magnetically fastening apparatus when the magnetically fastening apparatus is unlocked according to an embodiment of the present application.

FIG. 9 is a structural view of a magnetically fastening apparatus (in a fastening state) according to an embodiment of the present application.

FIG. 10 is a structural view of a magnetically fastening apparatus (in a releasing state) according to an embodiment of the present application.

FIG. 11 is an exploded view of a magnetically fastening apparatus according to an embodiment of the present application.

FIG. 12 is a view illustrating a structure in which a movable member of a magnetically fastening apparatus is plugged into a lock hole according to an embodiment of the present application.

FIG. 13 is a cross-sectional view taken along line B-B of FIG. 12.

FIG. 14 is a structural view illustrating the state in which lock bolts hook movable members when a control member of a magnetically fastening apparatus is in a fastening position according to an embodiment of the present application.

FIG. 15 is a structural view illustrating the state in which lock bolts disengage from movable members when a control member of a magnetically fastening apparatus is in a releasing position according to an embodiment of the present application.

FIG. 16 is a structural view of a magnetically fastening apparatus when the magnetically fastening apparatus is released according to an embodiment of the present application.

### REFERENCE LIST

100 zipper tab
110 second magnet
200 lock body
210 control member
220 housing
221 lock hole
222 limiting hole
231 first magnet
240 lock bolt
250 movable plate
260 reset member
270 coded lock mechanism
1 movable member
11 second magnet
2 body
21 control member
22 housing
24 lock bolt
25 movable plate
26 reset member
27 coded lock mechanism

### DETAILED DESCRIPTION

In the description of the present application, unless otherwise expressly specified and limited, the term “connected to each other”, “connected” or “secured” is to be construed in a broad sense, for example, as securely connected, detachably connected, or integrated; mechanically connected or electrically connected; directly connected to each other or indirectly connected to each other via an intermediary; or internally connected between two elements or interaction relations between two elements. For those of ordinary skill in the art, specific meanings of the preceding terms in this application may be understood based on specific situations.

In the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

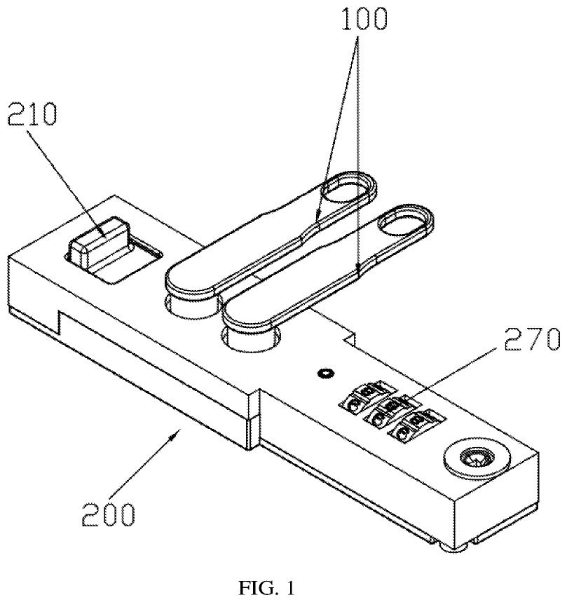

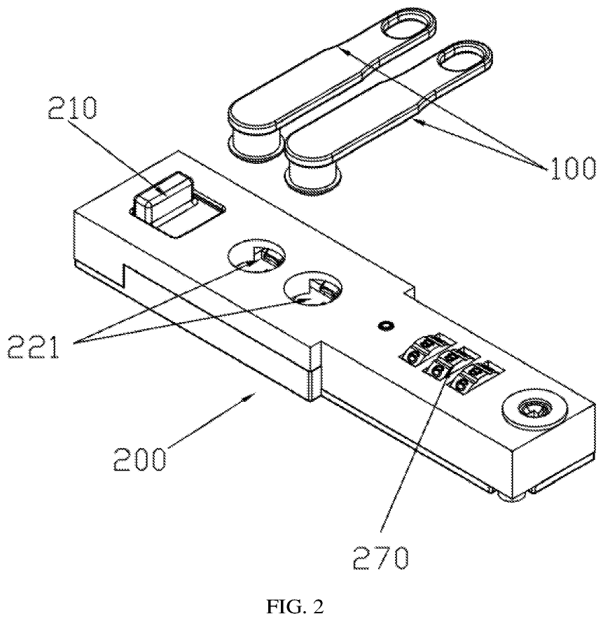

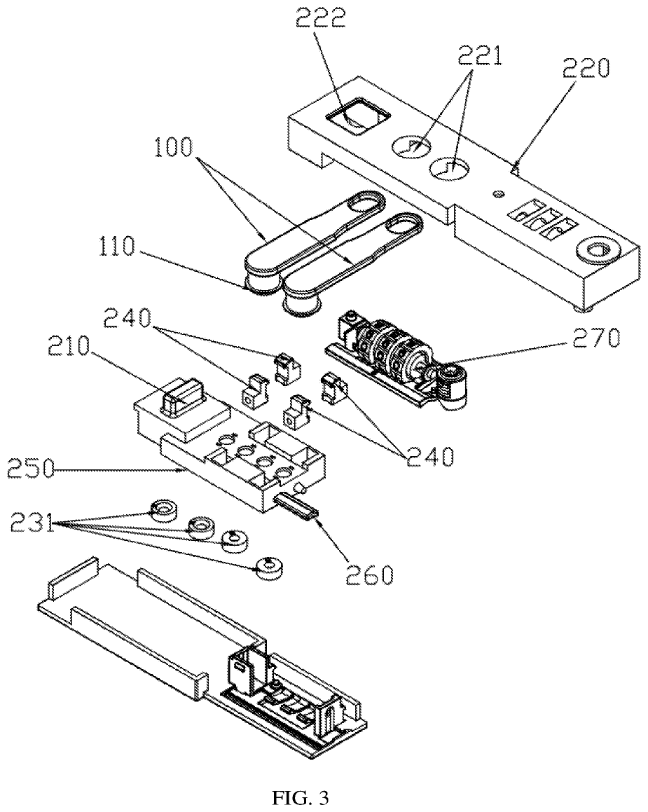

As shown in FIGS. 1 to 3, a magnetically fastening apparatus of the present application includes a zipper tab 100 and a lock body 200. The zipper tab 100 can fit with the lock body 200 by magnetic attraction. The lock body 200 is provided with a control member 210. The control member 210 has a locking position and an unlocking position. The zipper tab 100 can fit with the lock body 200 by magnetic attraction when the control member 210 is in the locking position. The zipper tab 100 and the lock body 200 can release the magnetic attraction relationship between the zipper tab 100 and the lock body 200 when the control member 210 is in the unlocking position. The zipper tab 100 fits with the lock body 200 by magnetic attraction so that when the zipper tab 100 gets close to the lock body 200 during the locking process, the zipper tab 100 is automatically attracted onto the lock body 200 due to the magnetic attraction relationship. The control member 210 is disposed so that the zipper tab 100 may automatically disengage from the lock body 200 when the control member 210 is in the unlocking position. This implements automatic locking and unlocking and is convenient to use.

In an embodiment, the lock body 200 includes a housing 220 and a magnet component disposed within the housing 220. The housing 220 is provided with a lock hole 211 that can fit with the zipper tab 100 in a plug-in manner. The magnet component includes multiple first magnets 231 arranged in sequence and located at the bottom of the lock hole 221. Adjacent first magnets have opposite polarities. The control member 210 can drive the magnet component to move between the locking position and the unlocking position. The zipper tab 100 is magnetically attracted using the multiple first magnets 231, and adjacent first magnets 231 have opposite polarities so that the relationship between the multiple first magnets 231 and the zipper tab 100 changes as positions of the multiple first magnets 231 changes. That is, a magnetic attraction relationship may change to a repulsion relationship, and a repulsion relationship may change to a magnetic attraction relationship. In this way, the zipper tab 100 fits with the lock body 200 by magnetic attraction when the control member 210 is in the locking position, and the zipper tab 100 and the lock body 200 release the magnetic attraction relationship between the zipper tab 100 and the lock body 200 when the control member 210 is in the unlocking position.

In the present application, in order that the zipper tab 100 fits with the magnet component by magnetic attraction, an end of the zipper tab 100 fitting with the lock hole 221 in a plug-in manner is provided with a second magnet 110. The magnetic attraction relationship and the repulsion relationship can be implemented through the interaction between the second magnet 110 and the multiple first magnets 231.

Exemplarily, in the present application, two lock holes 221 are disposed in the housing 220, the number of the zipper tabs 100 is two, second magnets 110 having the same polarity are disposed on the two zipper tabs 100 respectively, and the magnet component includes four first magnets 231. In the case that two zipper tabs 100 are provided, the number of the first magnets 231 may be four, and the four first magnets 231 are arranged in sequence with alternate polarities (for example, NSNS or SNSN). When two second magnets 110 each have a pole of S, each second magnet 110 is magnetically attracted by a respective first magnet 231 having a pole of N. When two first magnets 231 each having a pole of N are moved, two first magnets 231 each having a pole of S move below the two second magnets 110. Each first magnet repels a respective second magnet due to the same pole such that the two zipper tabs 100 disengage from the lock holes 221. In this way, the two zipper tabs 100 can be magnetically attracted onto the lock body 200 synchronously, or magnetic attraction relationships between the zipper tabs 100 and the lock body 200 may be synchronously released.

Additionally, in the present application, the housing 220 is further provided with a lock bolt 240 within the housing 220, and the lock bolt 240 is configured to hook the zipper tab 100 in a locking position and disengage from the zipper tab 100 in an unlocking position. The lock bolt 240 can ensure that the zipper tab 100 is tightly locked onto the lock body 200 during the locking so that the zipper tab 100 is prevented from falling away from the lock body 200 due to shaking or external force, thereby improving the safety.

Optionally, the number of lock bolts 240 is at least two, two lock bolts 240 are disposed opposite to each other, and the two opposite lock bolts 240 can get close to each other or get away from each other. In this way, the lock bolts 240 may hook the zipper tab 100 from both sides of the zipper tab 100 or disengage from the end of the zipper tab 100.

In the present application, in order that both the magnet component and the lock bolt 240 move between a locking position and an unlocking position, and both the magnet component and the lock bolt 240 are disposed on a movable plate 250. The movable plate 250 is connected to a control member 210. The control member 210 is configured to drive the movable plate 250 to move between a locking position and an unlocking position.

In the present application, in order that the magnet component and the lock bolt 240 quickly return from the unlocking position to the locking position, the movable plate 250 is connected to a reset member 260, and the reset member is configured to drive the movable plate 250 to move from the unlocking position to the locking position. The movable plate 250 can automatically and quickly return using the reset member 260, thus driving the magnet component and the lock bolt 240 to quickly return to the locking position. The reset member 260 may be a spring. A first end of the spring is connected to the movable plate 250. A second end of the spring is secured. When the movable plate 250 moves from the locking position to the unlocking position, the spring is compressed, and the spring pushes the movable plate 250 back under the action of elastic force, thereby resetting the movable plate 250.

In the present application, in order that the magnet component and the lock bolt 240 accurately move between the locking position and the unlocking position, the housing 220 is provided with a limiting hole 222, the control member 210 slidably fits with the limiting hole 222, and the limiting hole 222 is configured to limit a route of the control member 210 between the locking position and the unlocking position. By limiting the movement route of the control member 210, movements of the magnet component and the lock bolt 240 between the locking position and the unlocking position are accurately controlled.

Optionally, in the present application, the lock body 200 is further provided with a coded lock mechanism 270. The locking is implemented by cooperating with the coded lock mechanism 270.

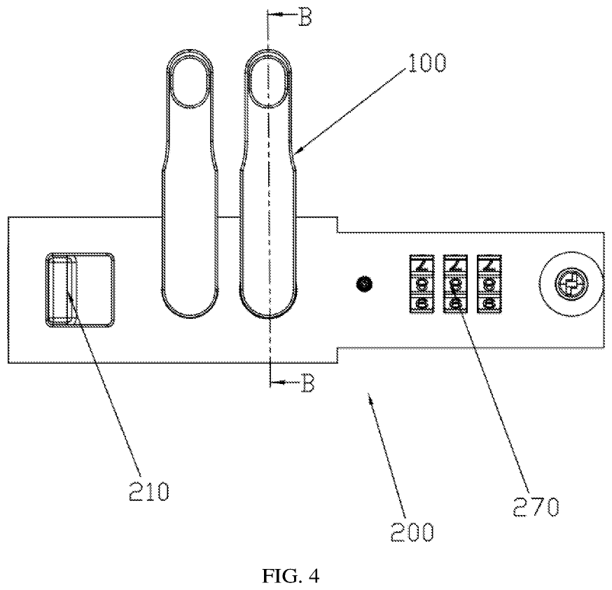

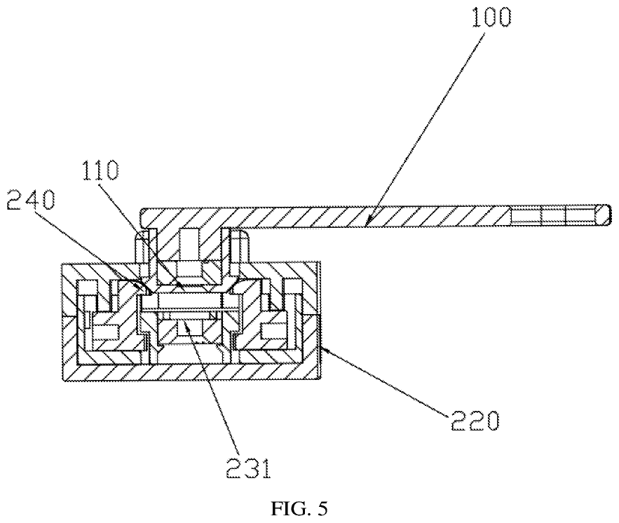

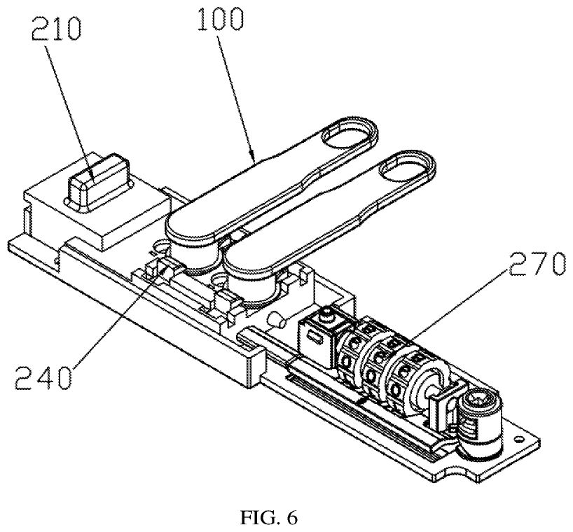

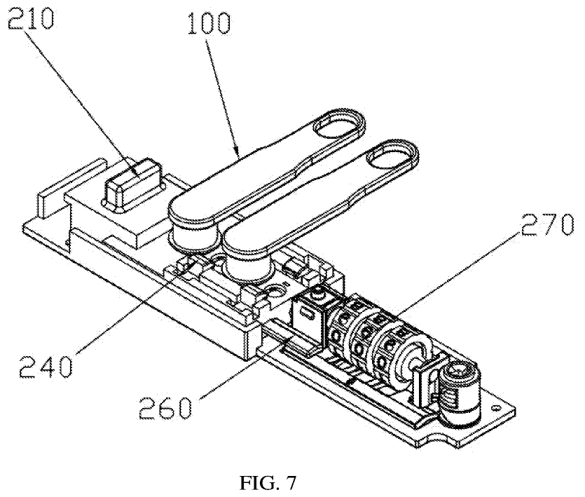

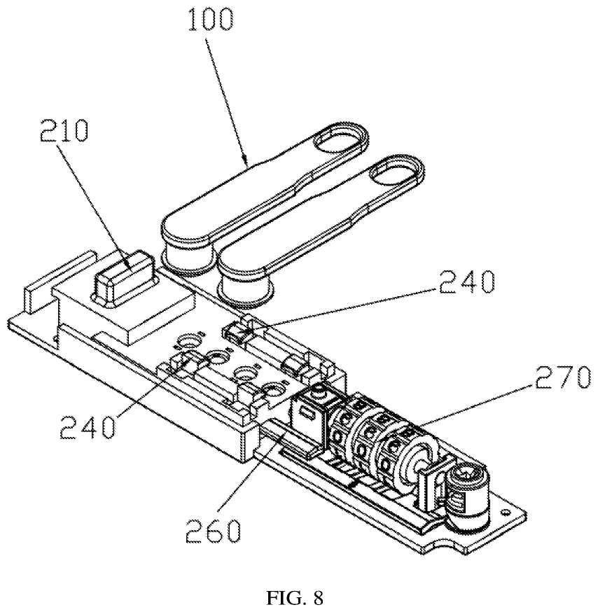

FIGS. 4 to 8 show the locking process and the unlocking process of a magnetically fastening apparatus according to the present application. During the locking, when a zipper tab 100 is pulled to a position close to a lock hole 221 in a lock body 200, a first magnet 231 and a second magnet 110 having opposite polarities attract each other, and an end of the zipper tab 100 is automatically plugged into the lock hole 221. During the plug-in process, the end of the zipper tab 100 abuts against lock bolts 240 on two sides of the zipper tab 100, so that the lock bolts 240 on two sides are opened outward, the end of the zipper tab 100 slides below the lock bolts 240, the lock bolts 240 on two sides are automatically reset and tightly hook the end of the zipper tab 100, and then, the locking is implemented using a coded lock mechanism 270. During the unlocking, the zipper tab 100 is released using the coded lock mechanism 270, then the control member 210 is moved, a first magnet 231 having the same pole as the second magnet 110 moves below the second magnet 110, and the lock bolts 240 hooking the end of the zipper tab 100 also disengage from the zipper tab 100. Due to magnetic repulsion, the zipper tab 100 disengages from the lock hole 221, thereby implementing the unlocking.

In view of the above, during the locking process or the unlocking process of a magnetic attraction lock of the present application, a zipper tab 100 can be automatically plugged into a lock hole 221 or automatically disengage from the lock hole 221. This is convenient to use.

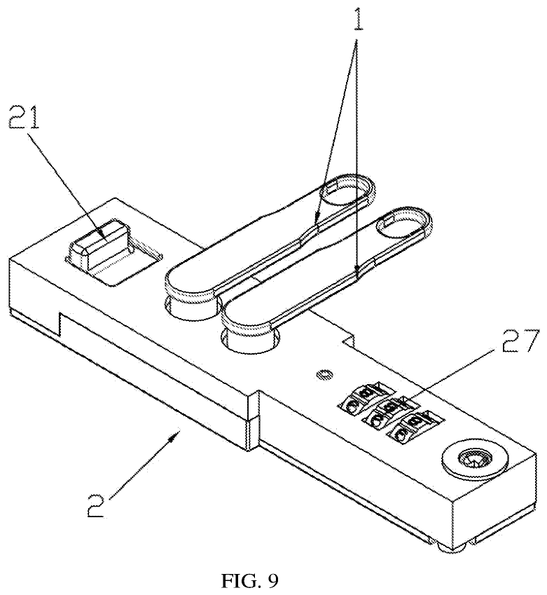

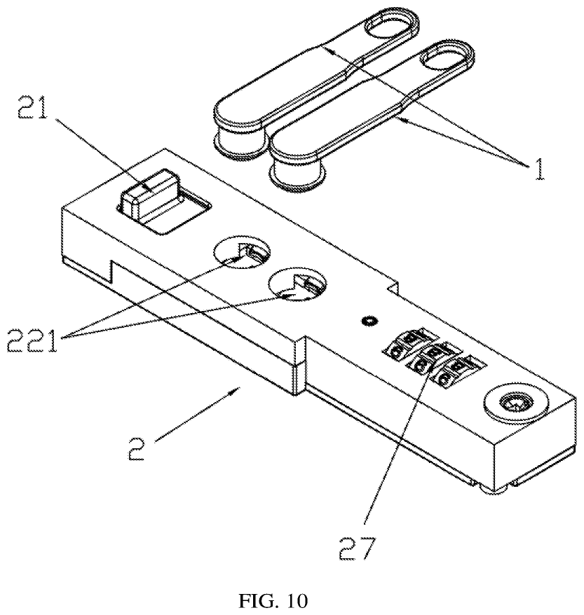

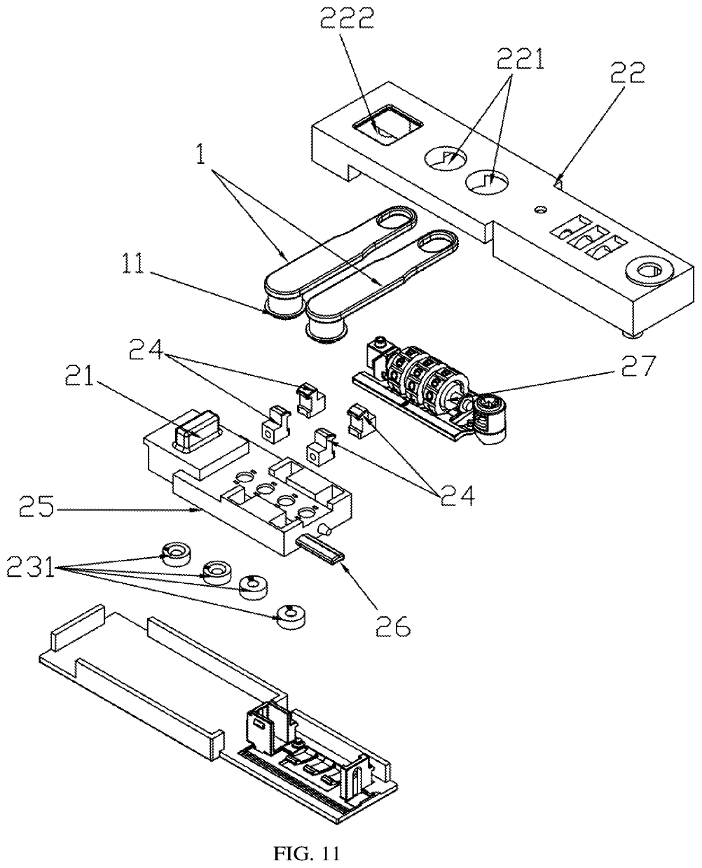

As shown in FIGS. 9 to 11, an embodiment of the present application provides a magnetically fastening apparatus. The magnetically fastening apparatus includes a movable member 1 and a body 2. The movable member 1 can fit with the body 2 by magnetic attraction.

The body 2 is provided with a control member 21. The control member 21 has a fastening position and a releasing position. The movable member 1 can fit with the body 2 by magnetic attraction when the control member 21 is in the fastening position. The movable member 1 and the body 2 can release the magnetic attraction relationship between the movable member 1 and the body 2 when the control member 21 is in the releasing position. The zipper tab 1 fits with the lock body 2 by magnetic attraction so that when the movable member 1 gets close to the body 2 during the fastening process, the movable member 1 is automatically attracted onto the body 2 due to the magnetic attraction relationship. The control member 210 is disposed, so that the movable member 1 may automatically disengage from the body 200 when the control member 210 is in the releasing position. This implements automatic fastening and releasing and is convenient to use.

In an embodiment, the body 2 includes a housing 22 and a magnet component disposed within the housing 22. The housing 22 is provided with a lock hole 221 that can fit with the movable member 100 in a plug-in manner. The magnet component includes multiple first magnets 231 arranged in sequence and located at the bottom of the lock hole 221. Adjacent first magnets have opposite polarities. The control member 210 can drive the magnet component to move between the fastening position and the releasing position. The movable member 1 is magnetically attracted using the multiple first magnets 231, and adjacent first magnets 231 have opposite polarities, so that the relationship between the multiple first magnet 231 and the movable member 1 changes as positions of the multiple first magnets 231 changes. That is, a magnetic attraction relationship may change to a repulsion relationship, and a repulsion relationship may change to a magnetic attraction relationship. In this way, the movable member 1 fits with the body 2 by magnetic attraction when the control member 21 is in the fastening position, and the movable member 1 and the body 2 releases the magnetic attraction relationship between the movable member 1 and the body 2 when the control member 21 is in the releasing position.

In the present application, in order that the movable member 1 fits with the magnet component by magnetic attraction, an end of the movable member 1 fitting with the lock hole 221 in a plug-in manner is provided with a second magnet 11. The magnetic attraction relationship and the repulsion relationship can be implemented through the interaction between the second magnet 11 and the multiple first magnets 231.

Exemplarily, in the present application, two lock holes 221 are disposed in the housing 22, the number of movable members 1 is two, second magnets 11 having the same polarity are disposed on the two movable members 1 respectively, and the magnet component includes four first magnets 231. In the case that two movable members 1 are provided, the number of first magnets 231 may be four, and the four first magnets 231 are arranged in sequence with alternate polarities (for example, NSNS or SNSN). When two second magnets 11 each have a pole of S, each second magnet 11 is magnetically attracted by a respective first magnet 231 having a pole of N. When two first magnets 231 each having a pole of N are moved, two first magnets 231 each having a pole of S move below the two second magnets 11. Each first magnet repels a respective second magnet due to the same pole such that the two movable members 1 disengage from lock holes 221. In this way, the two movable members 1 can be magnetically attracted onto the body 2 synchronously, or magnetic attraction relationships between the movable member 1 and the body 2 can be synchronously released.

Additionally, in the present application, the housing 220 is further provided with a lock bolt 24 is within the housing 22, and the lock bolt 24 is configured to hook the movable member 1 in the fastening position and disengage from the movable member 1 in the releasing position. The lock bolt 24 is provided to ensure that the movable member 1 is tightly locked onto the body 2 during the fastening, so that the movable member 1 is prevented from falling away from the body 2 due to shaking or external force, thereby improving the safety.

Optionally, the number of lock bolts 24 is at least two, two lock bolts 24 are disposed opposite to each other, and the two opposite lock bolts 240 can get close to each other or get away from each other. In this way, the lock bolts 24 may hook the movable member 1 from both sides of the movable member 1 or disengage from the end of the movable member 1.

In the present application, in order that both the magnet component and the lock bolt 24 move between the fastening position and the releasing position, both the magnet component and the lock bolt 24 are disposed on a movable plate 25. The movable plate 25 is connected to a control member 21. The control member 21 is configured to drive the movable plate 25 to move between the fastening position and the releasing position.

In the present application, in order that the magnet component and the lock bolt 24 quickly return from the releasing position to the fastening position, the movable plate 25 is connected to a reset member 26, and the reset member 26 is configured to drive the movable plate 25 to move from the releasing position to the fastening position. The movable plate 25 can automatically and quickly return using the reset member 26, thus driving the magnet component and the lock bolt 24 to quickly return to the fastening position. The reset member 26 may be a spring. A first end of the spring is connected to the movable plate 25. A second end of the spring is secured. When the movable plate 25 moves from the fastening position to the releasing position, the spring is compressed, and the spring pushes the movable plate 25 back under the action of elastic force, thereby resetting the movable plate 25.

In the present application, in order that the magnet component and the lock bolt 24 accurately move between the fastening position and the releasing position, the housing 220 is provided with a limiting hole 222, the control member 21 slidably fits with the limiting hole 222, and the limiting hole 222 is configured to limit a route of the control member 21 between the fastening position and the releasing position. By limiting the movement route of the control member 21, movements of the magnet component and the lock bolt 24 between the fastening position and the releasing position are accurately controlled.

Optionally, in the present application, the body 2 is further provided with a coded lock mechanism 27. The fastening is implemented by fitting with the coded lock mechanism 27.

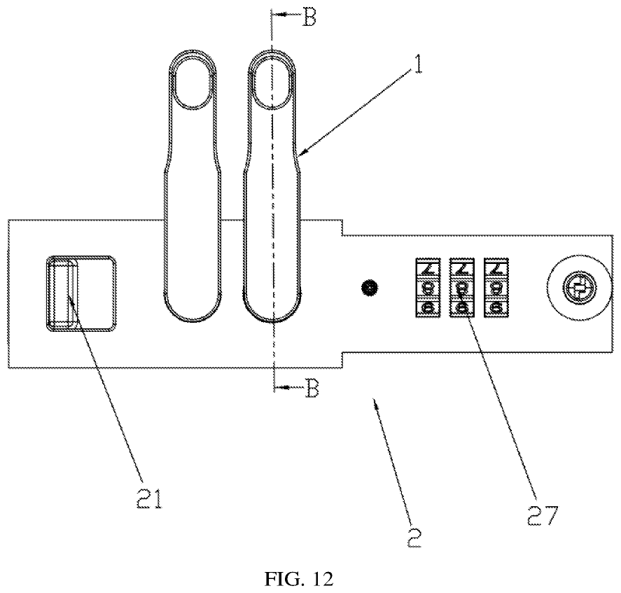

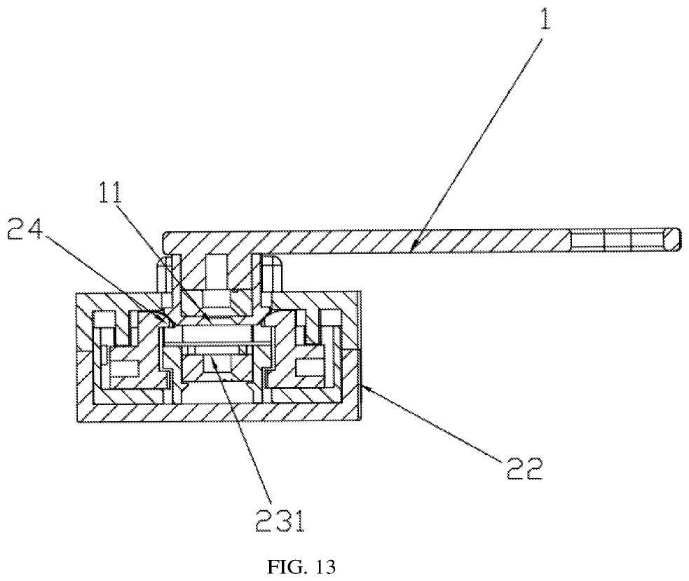

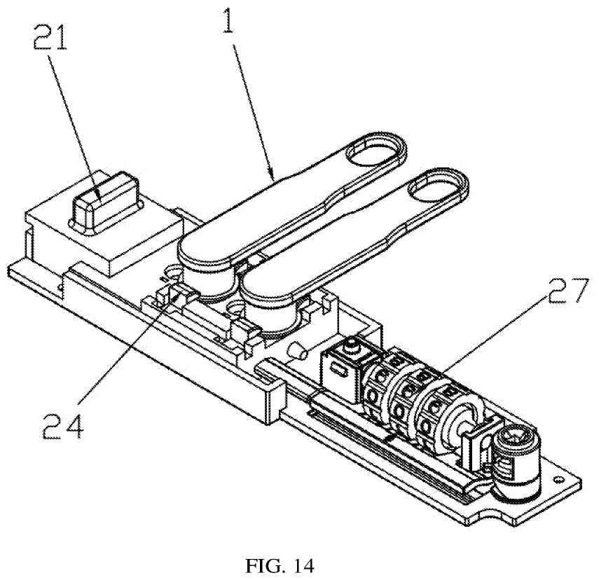

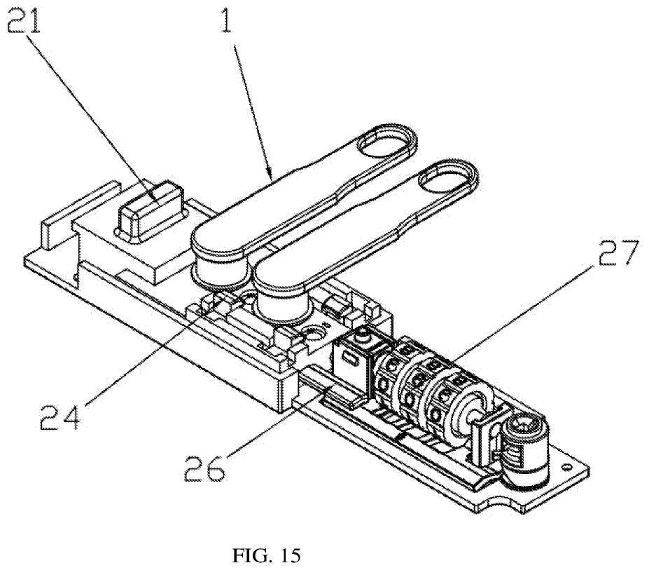

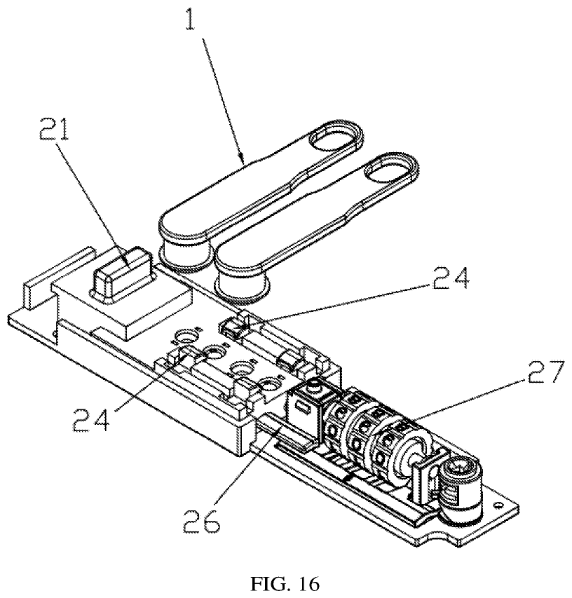

FIGS. 12 to 16 show the fastening process and the releasing process of a magnetically fastening apparatus according to the present application. During the fastening, when a movable member 1 is pulled to a position close to a lock hole 221 in a body 2, a first magnet 231 and a second magnet 11 having opposite polarities attract each other, and an end of the movable member 1 is automatically plugged into the lock hole 221. During the plug-in process, the end of the movable member 1 abuts against lock bolts 24 on two sides of the movable member 1, so that the lock bolts 24 on two sides are opened outward, the end of the movable member 1 slides below the movable member 24, the lock bolts 24 on two sides are automatically reset and tightly hook the end of the movable member 1, and then, the fastening is implemented using a coded lock mechanism 27. During the releasing, the movable member 1 is released using the coded lock mechanism 27, then the control member 21 is moved, a first magnet 231 having the same pole as the second magnet 11 is moved below the second magnet 11, and the lock bolts 24 hooking the end of the movable member 1 also disengage from the movable member 1. Due to magnetic repulsion, the movable member 1 disengages from the lock hole 221, thereby implementing the releasing.

In view of the above, during the fastening process or the releasing process of a magnetic attraction lock of the present application, a movable member 1 can be automatically plugged into a lock hole 221 or automatically disengage from the lock hole 221. This is convenient to use.

1. A magnetically fastening apparatus, comprising a zipper tab and a lock body, wherein
the lock body is provided with a control member, the control member has a locking position and an unlocking position, the zipper tab is configured to fit with the lock body by magnetic attraction when the control member is in the locking position, and the zipper tab and the lock body are configured to release a magnetic attraction relationship between the zipper tab and the lock body when the control member is in the unlocking position.

2. The magnetically fastening apparatus of claim 1, wherein the lock body comprises a housing and a magnet component disposed within the housing, wherein
the housing is provided with a lock hole configured to fit with the zipper tab in a plug-in manner;
the magnet component comprises a plurality of first magnets arranged in sequence and located at a bottom of the lock hole, and adjacent first magnets of the plurality of first magnets have opposite polarities; and
the control member is configured to drive the magnet component to move.

3. The magnetically fastening apparatus of claim 2, wherein an end of the zipper tab fitting with the lock hole in a plug-in manner is provided with a second magnet.

4. The magnetically fastening apparatus of claim 3, wherein the housing is provided with two lock holes, the magnetically fastening apparatus comprises two zipper tabs, second magnets having a same polarity are disposed on the two zipper tabs respectively, and the magnet component comprises four first magnets.

5. The magnetically fastening apparatus of claim 2, wherein the housing is further provided with a lock bolt within the housing, wherein the lock bolt is configured to hook the zipper tab when the control member is in the locking position, and the lock bolt is configured to disengage from the zipper tab when the control member is in the unlocking position.

6. The magnetically fastening apparatus of claim 5, further comprising a movable plate, wherein the magnet component and the lock bolt are disposed on the movable plate, the movable plate is connected to the control member, and the control member is configured to drive the movable plate to move.

7. The magnetically fastening apparatus of claim 6, wherein the housing is provided with at least two lock bolts, two lock bolts of the at least two lock bolts are disposed opposite to each other, and the two lock bolts opposite to each other are capable of getting close to each other or getting away from each other.

8. The magnetically fastening apparatus of claim 6, wherein the movable plate is connected to a reset member, wherein the reset member is configured to drive the movable plate to move.

9. The magnetically fastening apparatus of claim 2, wherein the housing is provided with a limiting hole, wherein the control member is configured to slidably fit with the limiting hole, and the limiting hole is configured to limit a route of the control member between the locking position and the unlocking position.

10. The magnetically fastening apparatus of claim 1, wherein the lock body is further provided with a coded lock mechanism.

11. A magnetically fastening apparatus, comprising a movable member and a body, wherein
the body is provided with a control member, the control member has a fastening position and a releasing position, the movable member is configured to fit with the body by magnetic attraction in the fastening position, and the movable member and the body are configured to release the magnetic attraction relationship between the movable member and the body in the releasing position.

12. The magnetically fastening apparatus of claim 11, wherein the body comprises a housing and a magnet component disposed within the housing, wherein
the housing is provided with a lock hole configured to fit with the movable member in a plug-in manner;
the magnet component comprises a plurality of first magnets arranged in sequence and located at a bottom of the lock hole, and adjacent first magnets of the plurality of first magnets have opposite polarities; and
the control member is configured to drive the magnet component to move.

13. The magnetically fastening apparatus of claim 12, wherein an end of the movable member fitting with the lock hole in a plug-in manner is provided with a second magnet.

14. The magnetically fastening apparatus of claim 13, wherein the housing is provided with two lock holes, the magnetically fastening apparatus comprises two movable members, second magnets having a same polarity are disposed on the two movable members respectively, and the magnet component comprises four first magnets.

15. The magnetically fastening apparatus of claim 12, wherein the housing is further provided with a lock bolt is within the housing, wherein the lock bolt is configured to hook the movable member when the control member is in the fastening position, and the lock bolt is configured to disengage from the movable member when the control member is in the releasing position.

16. The magnetically fastening apparatus of claim 15, further comprising a movable plate, wherein the magnet component and the lock bolt are disposed on the movable plate, the movable plate is connected to the control member, and the control member is configured to drive the movable plate to move.

17. The magnetically fastening apparatus of claim 16, wherein the housing is provided with at least two lock bolts, two lock bolts of the at least two lock bolts are disposed opposite to each other, and the two lock bolts opposite to each other are capable of getting close to each other or getting away from each other.

18. The magnetically fastening apparatus of claim 16, wherein the movable plate is connected to a reset member, wherein the reset member is configured to drive the movable plate to move.

19. The magnetically fastening apparatus of claim 12, wherein the housing is provided with a limiting hole, wherein the control member is configured to slidably fit with the limiting hole, and the limiting hole is configured to limit a route of the control member between the fastening position and the releasing position.

20. The magnetically fastening apparatus of claim 11, wherein the body is further provided with a coded lock mechanism.
